(19) United States
(12) Patent Application Publication
(10) Pub. No.: US 2025/0300350 A1
(43) Pub. Date: Sep. 25, 2025

(54) ANTENNA DEVICE

(71) Applicant: Getac Technology Corporation, New Taipei City (TW)

(72) Inventor: Yu-Yao CHANG, Taipei CIty (TW)

(21) Appl. No.: 19/021,346

(22) Filed: Jan. 15, 2025

(30) Foreign Application Priority Data
Mar. 22, 2024 (CN) 202410333972.6

(51) Int. Cl. H01Q 7/00; H01Q 5/20; H01Q 5/314; H01Q 9/04

(52) U.S. Cl. CPC H01Q 7/00; H01Q 5/20; H01Q 5/314; H01Q 9/0407

(57) ABSTRACT

An antenna device, comprising a loop antenna and a passive radiating element. The loop antenna comprises a first terminal of the loop antenna and a second terminal of the loop antenna. The first terminal of the loop antenna is coupled to a feed terminal, and the second terminal of the loop antenna is coupled to a ground terminal. The passive radiating element comprises a first terminal of the passive radiating element and a second terminal of the passive radiating element. The first terminal of the passive radiating element is coupled to the feed terminal, and the second terminal of the passive radiating element has a coupling section. The coupling section and at least one portion of the loop antenna are substantially parallel to each other and have a first spacing to form a coupling capacitor.

### CROSS-REFERENCE TO RELATED APPLICATION

This application claims priority to China Application Serial Number 202410333972.6, filed Mar. 22, 2024, which is herein incorporated by reference in its entirety.

### BACKGROUND

### Technical Field

The present disclosure relates to antenna technology, and in particular to an antenna device.

### Description of Related Art

Due to the rapid development of communication technology, communication technology has become an indispensable part of modern life. With the improvement of the quality of life, people are increasingly demanding the transmission rate and signal quality of electronic devices for sending and receiving signals. Therefore, how to make the corresponding improvements to the antenna based on application requirements, balancing the cost, size and performance of the antenna has become a critical issue at present.

### SUMMARY

One aspect of the present disclosure is an antenna device, comprising a loop antenna and a passive radiating element. The loop antenna comprises a first terminal of the loop antenna and a second terminal of the loop antenna. The first terminal of the loop antenna is coupled to a feed terminal, and the second terminal of the loop antenna is coupled to a ground terminal. The passive radiating element comprises a first terminal of the passive radiating element and a second terminal of the passive radiating element. The first terminal of the passive radiating element is coupled to the feed terminal, and the second terminal of the passive radiating element has a coupling section. The coupling section and at least one portion of the loop antenna are substantially parallel to each other and have a first spacing to form a coupling capacitor.

Another aspect of the present disclosure is an antenna device, comprising a loop antenna and a inductor element. The loop antenna comprises a ground section, a feed section and a radiating section. The ground section is coupled to a ground terminal, the feed section is coupled to a feed terminal, the radiating section is coupled between the ground section and the feed section, and has a coupling portion. A first terminal of the inductor element is coupled to the feed terminal, and a second terminal of the inductor element has a coupling section. An extension direction of the coupling section is equal to an extension direction of the coupling portion, so as to form a coupling capacitor between the inductor element and the loop antenna.

Another aspect of the present disclosure is an antenna device, comprising a substrate, a loop antenna and a patch antenna. The loop antenna is arranged on a first side of the substrate, and comprises a ground section, a feed section and a radiating section. The ground section is coupled to a ground terminal, and the feed section is coupled to a feed terminal. The patch antenna is arranged at a position on a second side of the substrate corresponding to the feed section, and is configured to provide frequency response when the antenna device transmits a first frequency signal, wherein a frequency of the first frequency signal is between 4000 Hz and 6000 Hz.

It is to be understood that both the foregoing general description and the following detailed description are by examples, and are intended to provide further explanation of the disclosure as claimed.

### BRIEF DESCRIPTION OF THE DRAWINGS

The present disclosure can be more fully understood by reading the following detailed description of the embodiment, with reference made to the accompanying drawings as follows:

FIG. 1A is a first side schematic diagram of an antenna device in some embodiments of the present disclosure.

FIG. 1B is a second side schematic diagram of an antenna device in some embodiments of the present disclosure.

FIG. 2 is a first side schematic diagram of an antenna device in some embodiments of the present disclosure.

FIG. 3 is a frequency response characteristic diagram of an antenna device in some embodiments of the present disclosure.

FIG. 4 is a second side schematic diagram of an antenna device in some embodiments of the present disclosure.

FIG. 5 is a frequency response characteristic diagram of an antenna device in some embodiments of the present disclosure.

FIG. 6 is a frequency response characteristic diagram of an antenna device in some embodiments of the present disclosure.

### DETAILED DESCRIPTION

For the embodiment below is described in detail with the accompanying drawings, embodiments are not provided to limit the scope of the present disclosure. Moreover, the operation of the described structure is not for limiting the order of implementation. Any device with equivalent functions that is produced from a structure formed by a recombination of elements is all covered by the scope of the present disclosure. Drawings are for the purpose of illustration only, and not plotted in accordance with the original size.

It will be understood that when an element is referred to as being “connected to” or “coupled to”, it can be directly connected or coupled to the other element or intervening elements may be present. In contrast, when an element to another element is referred to as being “directly connected” or “directly coupled,” there are no intervening elements present. As used herein, the term “and/or” includes an associated listed items or any and all combinations of more.

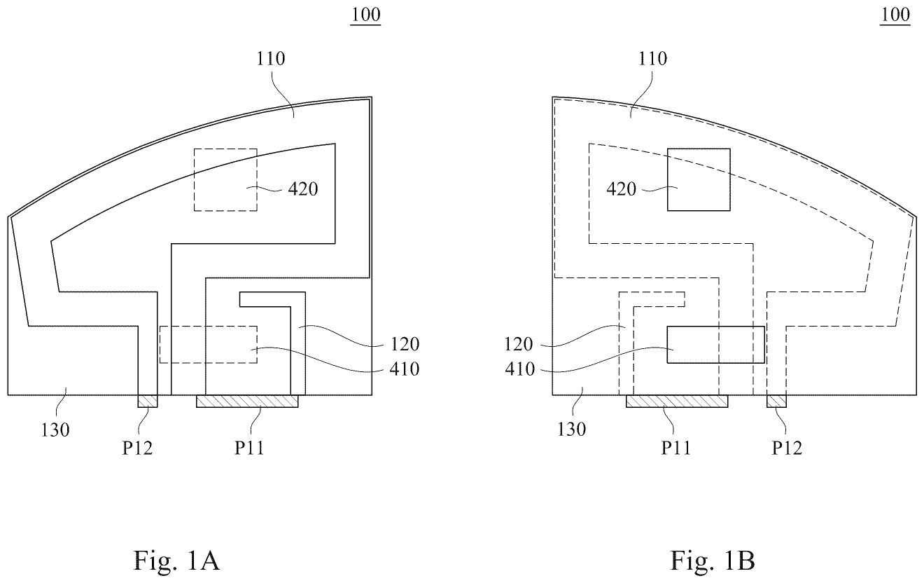

FIG. 1A and FIG. 1B are an antenna device 100 in some embodiments of the present disclosure. FIG. 1A is a first side schematic diagram of the antenna device 100, and FIG. 1B is a second side schematic diagram of the antenna device 100. The antenna device 100 is configured to coupled to an electronic device (e.g., computer host) to send and receive signals. In one embodiment, the antenna device 100 is applied in a vehicle communication system, and can be arranged on the body or top of the vehicle. The antenna device 100 is communicatively connected to a communication circuit or a microprocessor in the vehicle communication system to send and receive signals, but the present disclosure is not limited to the disclosed embodiment.

As shown in FIG. 1A, the antenna device 100 includes a loop antenna 110 and a passive radiating element 120. In one embodiment, both of the loop antenna 110 and the passive radiating element 120 are arranged on the first side of the substrate 130. The substrate 130 is made of insulating material, the loop antenna 110 is made of conductive material, and two terminals of the loop antenna 110 are arranged on the same side on the first side of the substrate 130.

Specifically, a first terminal of the loop antenna 110 is coupled to a feed terminal P11, and a second terminal of the loop antenna 110 is coupled to a ground terminal P12. The feed terminal P11 is coupled to a processor (e.g., communication circuit in the vehicle communication system), and is configured to send communication signals. The ground terminal P12 is coupled to a ground portion (e.g., a shell of a metal device shell or a vehicle body). Since those skilled in the art can understand the configuration of feed signals and ground signal, thus they are not further detailed herein.

In one embodiment, the loop antenna 110 can be implemented by a folded dipole antenna, a square loop antenna, a delta loop antenna or a double rectangular loop antenna, but the present disclosure is not limited to the disclosed structures.

The passive radiating element 120 is a conductor material, in one embodiment, the passive radiating element 120 may be an inductor element (i.e., an inductor, or a conductor forming part of an inductor). A first terminal of the passive radiating element 120 is coupled to the feed terminal P11, and a second terminal of the passive radiating element 120 extends in a direction away from the feed terminal P11 and close to the loop antenna 110. The second terminal of the passive radiating element 120 and a portion of the loop antenna 110 are substantially parallel to each other, and there is a first spacing D11 between the second terminal of the passive radiating element 120 and the portion of the loop antenna 110. The passive radiating element 120 and the corresponding portion of the loop antenna 110 can form a coupling capacitor by the first spacing D11. The capacitive effect formed by the coupling capacitor will improve the transmission effect of the antenna device 100 in the low-frequency band and increase the transmission bandwidth of the antenna device 100.

In one embodiment, the first terminal of the passive radiating element 120 has a connecting section 121. The connecting section 121 can be used as an impedance element, and is coupled to the feed terminal P11. The second terminal of passive radiating element 120 can be used as a coupling section 122, and is configured to form the coupling capacitor with the corresponding portion of the loop antenna 110. The width of the coupling section 122 (i.e., a conductor volume used to form the coupling capacitor) is larger than the width of the connecting section 121 (i.e., a volume of the portion used to connect to the feed terminal P11). The actual width can be adjusted according to actual needs.

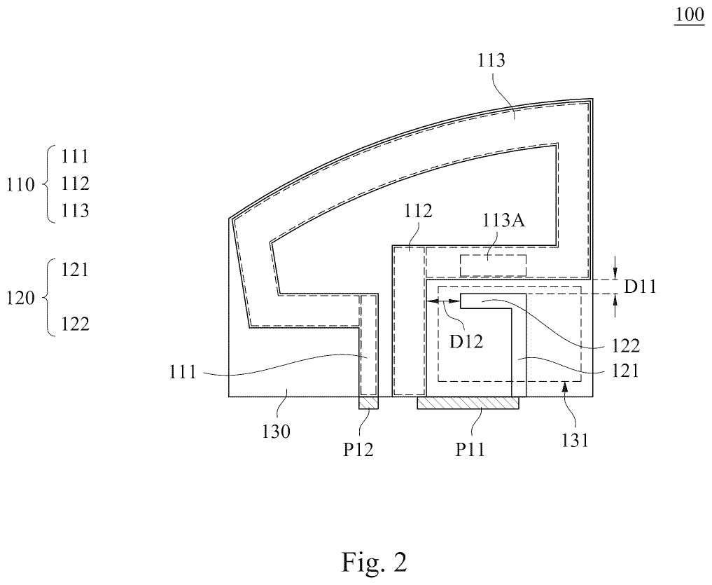

FIG. 2 is a first side schematic diagram of the antenna device 100 in some embodiments of the present disclosure. Referring to FIG. 1A and FIG. 2, in one embodiment, the loop antenna 110 includes a ground section 111, a feed section 112 and a radiating section 113. The ground section 111 is coupled to the ground terminal P12. The feed section 112 is coupled to the feed terminal P11. The radiating section 113 is coupled between the ground section 111 and the feed section 112, and at least one portion of the radiating section 113 is used to be a coupling portion 113A. In one embodiment, the coupling portion 113A means a portion the radiating section 113 adjacent to the feed section 112. An extension direction of the coupling section 122 of passive radiating element 120 is equal to an extension direction of the coupling portion 113A (as shown in the left and right directions in FIG. 2), so as to form the coupling capacitor between the passive radiating element 120 (the inductor element) and the loop antenna 110.

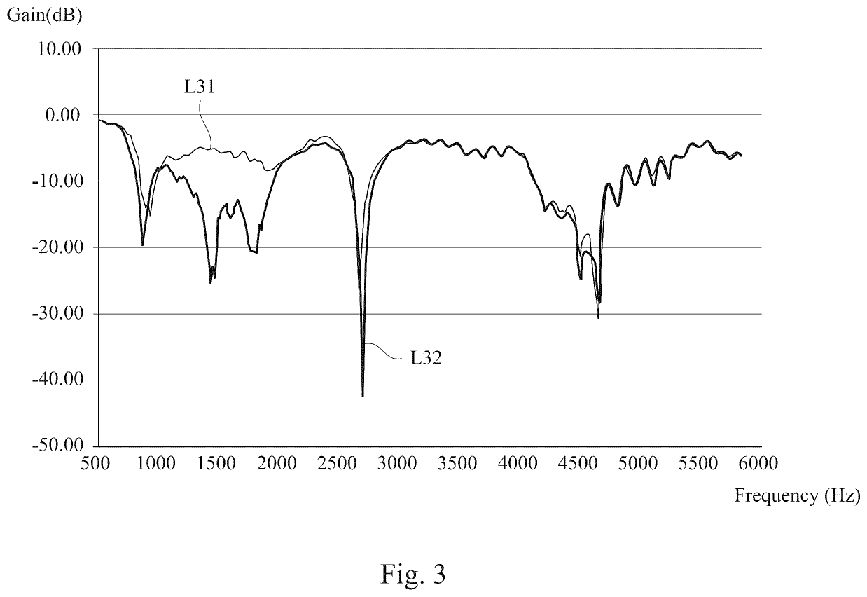

FIG. 3 is a frequency response characteristic diagram of an antenna device 100 in some embodiments of the present disclosure. In FIG. 3, the horizontal axis represents the signal frequency, and the vertical axis represents the gain, measured in decibels (dB). Generally, a gain lower than −10 dB ensures the accuracy of sending and receiving signals. In other words, the frequency range with a gain lower than −10 dB represents the bandwidth of the antenna device 100. However, it should be noted that the gain standard is not limited to −10 dB. Depending on different usage scenarios and application devices, the gain standard can also be −6 dB or −20 dB. In this embodiment, −10 dB is used as an example for explanation.

As shown in FIG. 3, a characteristic curve L31 is the frequency response characteristic when sending and receiving signals by the loop antenna 110 (i.e., not includes the passive radiating element 120), and a characteristic curve L32 is the frequency response characteristic when the loop antenna 110 and the passive radiating element 120 cooperate with each other to send and receive signals. It can be clearly seen from the frequency response characteristic diagram that the response effect of the characteristic curve L32 in the low frequency band (e.g., 1000 Hz to 2000 Hz) is improved. Therefore, when the loop antenna 110 and the passive radiating element 120 cooperate with each other, the bandwidth of the antenna device 100 can be increased.

Referring to FIG. 1A and FIG. 2, in one embodiment, there is a first angle between the feed section 112 and the radiating section 113 of the loop antenna 110, so that a configuration space 131 is formed in the area between the feed section 112 and the radiating section 113 on the substrate 130. The passive radiating element 120 is arranged in the configuration space 131. In other words, the position of the passive radiating element 120 corresponds to a position between the feed section 112 and the radiating section 113, so that the position of the coupling section 122 is adjacent to the coupling portion 113A.

In addition, in one embodiment, there is a second angle between the connecting section 121 and the coupling section 122 of the passive radiating element 120, so that the coupling section 122 and at least one portion of the radiating section 113 (i.e., the coupling portion 113A) are substantially parallel to each other, so as to form the coupling capacitor. In some embodiments, the second angle can be a right angle or close to a right angle (e.g., between 75 degrees and 120 degrees), so that the configuration of the connecting section 121 and the coupling section 122 substantially forms an L-shape. In other embodiments, there is no bend between the connecting section 121 and the coupling section 122, and the passive radiating element 120 forms the coupling section 122 by changing the width between the two terminals. For example, the area of the passive radiating element 120 is a trapezoid. The width at a first terminal coupled to the feed terminal P11 is smaller, while the width at a second terminal adjacent to the radiating section 113 is larger.

In one embodiment, the ratio between the first spacing D11 (which is between the coupling portion 113A and the coupling section 122) and the width of the coupling section 122 is between 0.4 and 2. In some embodiments, the first spacing D11 is between 1 millimeters and 5 millimeters, and the width of the coupling section 122 is between 2 millimeters and 2.5 millimeters. In other embodiments, the first spacing D11 is between 1 millimeters and 3 millimeters, and the width of the coupling section 122 is 2.5 millimeters.

In one embodiment, there is a second spacing D12 between the coupling section 122 and the feed section 112 of the loop antenna 110. The second spacing D12 is between 6 millimeters and 13 millimeters, but the present disclosure is not to limited to the disclosed embodiment.

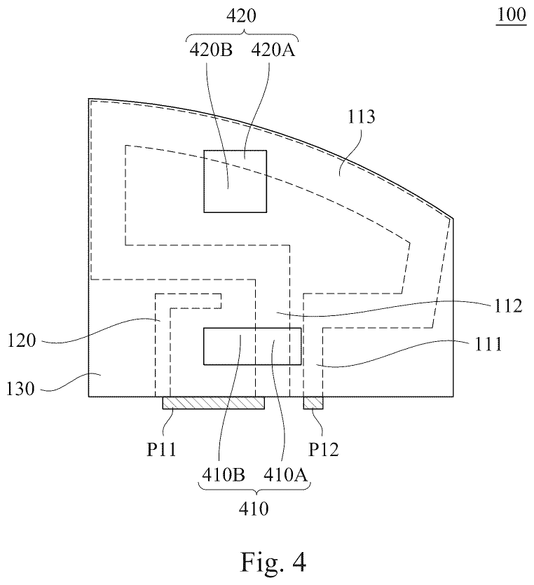

Referring to FIG. 1A, FIG. 1B and FIG. 4, FIG. 4 is a second side schematic diagram of an antenna device 100 in some embodiments of the present disclosure. In one embodiment, the second side of the substrate 130 has a first patch antenna 410. The first patch antenna 410 is arranged at a position corresponding to the feed section 112 of the loop antenna 110. The first patch antenna 410 is configured to provide frequency response when the antenna device 100 transmits/sends or receives a first frequency signal. In one embodiment, the first patch antenna 410 is an n77 antenna. In other words, the first patch antenna 410 is implemented on n77 frequency band, and the frequency of the corresponding first frequency signal is between 4000 Hz and 6000 Hz.

In one embodiment, the position of the first patch antenna 410 and the position of the the loop antenna 110 partially overlaps (i.e., in the corresponding areas on both sides of the substrate 130), but does not overlap with the passive radiating element 120. As shown in FIG. 4, the first portion 410A of the first patch antenna 410 overlaps with the feed section 112. The second portion 410B of the first patch antenna 410 does not overlap with the feed section 112, and an area ratio between the first portion 410A and the second portion 410B is between 1.5 and 2.5. In one embodiment, the first patch antenna 410 has a length of 15 millimeters and a width of 6 millimeters.

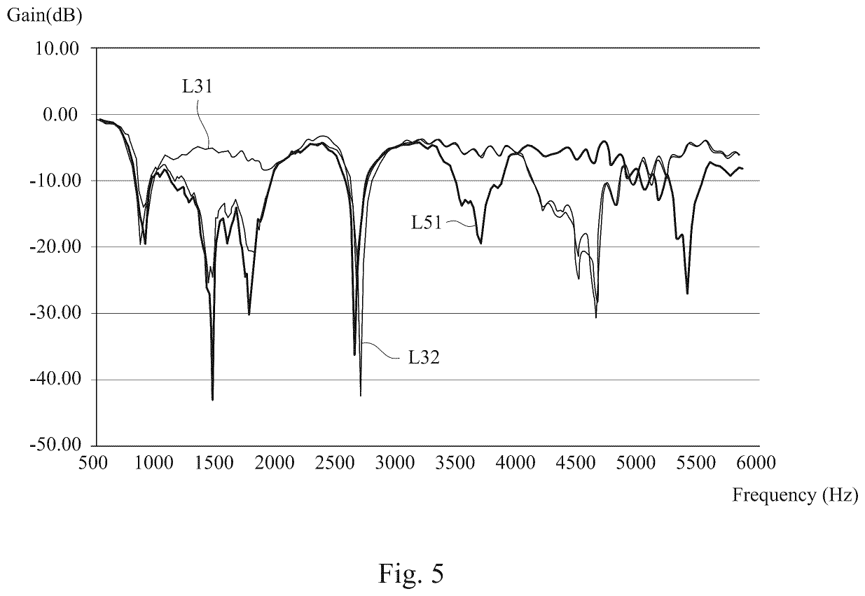

FIG. 5 is a frequency response characteristic diagram of an antenna device 100 in some embodiments of the present disclosure. In FIG. 5, the characteristic curve L32 is the same as the FIG. 3, and represents the frequency response characteristic when the loop antenna 110 and the passive radiating element 120 cooperate with each other to send and receive signals. The characteristic curve L51 represents the frequency response characteristics when the loop antenna 110, the passive radiating element 120 and the first patch antenna 410 cooperate with each other to send and receive signals. It can be seen from the frequency response characteristic diagram that compared with the characteristic curve L32, the response effect of the characteristic curve L51 in the frequency band of 3500 Hz to 4200 Hz and 5000 Hz to 6000 Hz is improved. In addition, the characteristic curve L51 still maintains a similar response effect at high frequencies (e.g., 5G frequency band), and the response effect will not be attenuated due to the use of the first patch antenna 410.

As shown in FIG. 4, in one embodiment, the antenna device 100 has a second patch antenna 420 on the second side of the substrate 130. The second patch antenna 420 is arranged at a position corresponding to the position of the radiating section 113 of the loop antenna 110. The second patch antenna 420 is configured to provide frequency response when the antenna device 100 sends/transmits or receives a second frequency signal. In one embodiment, the second patch antenna 420 is a B7 antenna. In other words, the second patch antenna 420 is implemented on B7 frequency band, and the frequency of the corresponds second frequency signal is between 2500 Hz and 3000 Hz. In other embodiments, the frequency of the second frequency signal is between 2500 Hz and 2690 Hz.

Referring to FIG. 1B and FIG. 4, in one embodiment, the position of the second patch antenna 420 and the position of the the loop antenna 110 partially overlaps (i.e., in the corresponding areas on both sides of the substrate 130), but does not overlap with the passive radiating element 120. As shown in FIG. 4, the first portion 420A of the second patch antenna 420 overlaps with the radiating section 113 of the loop antenna 110. The second portion 420B of the second patch antenna 420 does not overlap with the radiating section 113, and an area ratio between the the first portion 420A and the second portion 420B is between 0.8 and 1.2. In one embodiment, an area ratio between the first portion 420A and the second portion 420B is 1. In one embodiment, the second patch antenna 420 is a square with a side length of 10 millimeters.

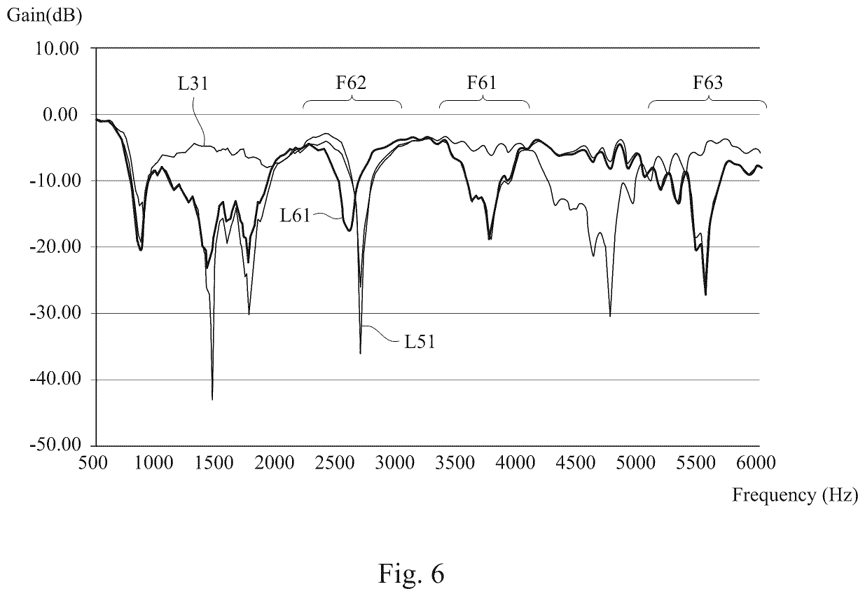

FIG. 6 is a frequency response characteristic diagram of an antenna device 100 in some embodiments of the present disclosure. In FIG. 6, the characteristic curve L51 is the same as the FIG. 5, and represents the frequency response characteristic when the loop antenna 110, the passive radiating element 120 and the first patch antenna 410 cooperate with each other to send and receive signals. The characteristic curve L61 represents the frequency response characteristic when the loop antenna 110, the passive radiating element 120 and the second patch antenna 420 (not include the first patch antenna 410) cooperate with each other to send and receive signals. It can be seen from the frequency response characteristic diagram that the response effect of the characteristic curve L61 in the frequency band of 2500 to 3000 Hz, 3500 to 4000 Hz and 5500 to 6000 Hz is improved, as frequency band F61, F62, F63 shown in FIG. 6.

In the embodiment shown in FIG. 1A and FIG. 1B, the passive radiating element 120 (the inductor element) is arranged on one side of the antenna device 100, and the first patch antenna 410 and the second patch antenna 420 are arranged on the other side of the antenna device 100. However, in some other embodiments, the antenna device 100 can also select one or more of the passive radiating element 120, the first patch antenna 410 and the second patch antenna 420 to cooperate with the loop antenna 110 according to transmission requirements to enhance the frequency response of a specific frequency band.

The elements, method steps, or technical features in the foregoing embodiments may be combined with each other, and are not limited to the order of the specification description or the order of the drawings in the present disclosure.

It will be apparent to those skilled in the art that various modifications and variations can be made to the structure of the present disclosure without departing from the scope or spirit of the present disclosure. In view of the foregoing, it is intended that the present disclosure cover modifications and variations of this present disclosure provided they fall within the scope of the following claims.

What is claimed is:

1. An antenna device, comprising:
a loop antenna comprising a first terminal of the loop antenna and a second terminal of the loop antenna, wherein the first terminal of the loop antenna is coupled to a feed terminal, and the second terminal of the loop antenna is coupled to a ground terminal; and
a passive radiating element comprising a first terminal of the passive radiating element and a second terminal of the passive radiating element, wherein the first terminal of the passive radiating element is coupled to the feed terminal, and the second terminal of the passive radiating element has a coupling section;
wherein the coupling section and at least one portion of the loop antenna are substantially parallel to each other and have a first spacing to form a coupling capacitor.

2. The antenna device of claim 1, wherein the loop antenna further comprises a feed section and a radiating section, the feed section is coupled to the feed terminal, a first angle is between the feed section and the radiating section to form a configuration space, and the passive radiating element is arranged in the configuration space.

3. The antenna device of claim 2, wherein the first terminal of the passive radiating element has a connecting section, the connecting section is connected to the feed terminal, a second angle is between the connecting section and the coupling section, and the coupling section and at least one portion of the radiating section are substantially parallel to each other.

4. The antenna device of claim 2, wherein a second spacing between the coupling section and the feed section is between 6 millimeters and 13 millimeters.

5. The antenna device of claim 1, wherein a ratio between the first spacing and a width of the coupling section is between 0.4 and 2.

6. The antenna device of claim 1, wherein the first spacing is between 1 millimeters and 13 millimeters.

7. The antenna device of claim 1, further comprising:
a substrate, wherein the loop antenna and the passive radiating element are arranged on a first side of the substrate, and the loop antenna comprises a feed section, a radiating section and a ground section.

8. The antenna device of claim 7, further comprising:
a first patch antenna arranged at a position on a second side of the substrate corresponding to the feed section, wherein the first patch antenna is configured to provide frequency response when the antenna device transmits a first frequency signal, and a frequency of the first frequency signal is between 4000 Hz and 6000 Hz.

9. The antenna device of claim 8, wherein a first portion of the first patch antenna overlaps with the feed section, a second portion of the first patch antenna does not overlap with the feed section, and an area ratio between the first portion and the second portion is between 1.5 and 2.5.

10. The antenna device of claim 7, further comprising:
a second patch antenna arranged at a position on a second side of the substrate corresponding to the radiating section, wherein the second patch antenna is configured to provide frequency response when the antenna device transmits a second frequency signal, and a frequency of the second frequency signal is between 2500 Hz and 3000 Hz.

11. The antenna device of claim 10, wherein a first portion of the second patch antenna overlaps with the radiating section, a second portion of the second patch antenna does not overlap with the radiating section, and an area ratio between the first portion and the second portion is between 0.8 and 1.2.

12. An antenna device, comprising:
a loop antenna comprising a ground section, a feed section and a radiating section, wherein the ground section is coupled to a ground terminal, the feed section is coupled to a feed terminal, the radiating section is coupled between the ground section and the feed section, and has a coupling portion; and
an inductor element, wherein a first terminal of the inductor element is coupled to the feed terminal, and a second terminal of the inductor element has a coupling section;
wherein an extension direction of the coupling section is equal to an extension direction of the coupling portion, so as to form a coupling capacitor between the inductor element and the loop antenna.

13. The antenna device of claim 12, wherein a first angle is between the feed section and the coupling portion to form a configuration space, and the inductor element is arranged in the configuration space.

14. The antenna device of claim 12, wherein a first spacing is between the coupling section and the coupling portion, and a ratio between the first spacing and a width of the coupling section is between 0.4 and 2.

15. The antenna device of claim 12, wherein a second spacing between the coupling section and the feed section is between 6 millimeters and 13 millimeters.

16. The antenna device of claim 12, further comprising:
a substrate, wherein the loop antenna and the inductor element are arranged on a first side of the substrate; and
a first patch antenna arranged at a position on a second side of the substrate corresponding to the feed section, wherein the first patch antenna is configured to provide frequency response when the antenna device transmits a first frequency signal, and a frequency of the first frequency signal is between 4000 Hz and 6000 Hz.

17. The antenna device of claim 16, wherein a first portion of the first patch antenna overlaps with the feed section, a second portion of the first patch antenna does not overlap with the feed section, and an area ratio between the first portion and the second portion is between 1.5 and 2.5.

18. The antenna device of claim 12, further comprising:
a substrate, wherein the loop antenna and the inductor element are arranged on a first side of the substrate; and
a second patch antenna arranged at a position on a second side of the substrate corresponding to the radiating section, wherein the second patch antenna is configured to provide frequency response when the antenna device transmits a second frequency signal, wherein a frequency of the second frequency signal is between 2500 Hz and 3000 Hz.

19. An antenna device, comprising:
a substrate;
a loop antenna arranged on a first side of the substrate, comprising a ground section, a feed section and a radiating section, wherein the ground section is coupled to a ground terminal, and the feed section is coupled to a feed terminal; and
a patch antenna arranged at a position on a second side of the substrate corresponding to the feed section, wherein the patch antenna is configured to provide frequency response when the antenna device transmits a first frequency signal, and a frequency of the first frequency signal is between 4000 Hz and 6000 Hz.

20. The antenna device of claim 19, further comprising:
a passive radiating element arranged on the first side of the substrate, and not overlapping with the patch antenna, wherein the passive radiating element comprises a coupling section, and the coupling section and at least one portion of the radiating section are substantially parallel to each other and have a spacing to form a coupling capacitor.
